(19) United States
(12) Patent Application Publication
(10) Pub. No.: US 2024/0124707 A1
(43) Pub. Date: Apr. 18, 2024

(54) POLYESTER COMPOSITE BOARD STRUCTURE AND MANUFACTURING METHOD THEREOF

(71) Applicant: NAN YA PLASTICS CORPORATION, Taipei (TW)

(72) Inventors: Te-Chao Liao, TAIPEI (TW); Chun-Che Tsao, TAIPEI (TW); Wen-Jui Cheng, TAIPEI (TW); Yueh-Shin Liu, TAIPEI (TW)

(73) Assignee: NAN YA PLASTICS CORPORATION, TAIPEI (TW)

(21) Appl. No.: 17/993,882

(22) Filed: Nov. 24, 2022

(30) Foreign Application Priority Data
Oct. 18, 2022 (TW) 111139347

(51) Int. Cl. C08L 67/08

(52) U.S. Cl. CPC C08L 67/08; C08L 2203/16; C08L 2207/04

(57) ABSTRACT

The disclosure provides a polyester composite board structure and a manufacturing method thereof. The manufacturing method includes extruding a polyester layer into a board using a multi-layer extrusion equipment, and laminating a polyester film by heat using a wheel during an extrusion process.

### CROSS-REFERENCE TO RELATED APPLICATION

This application claims the priority benefit of Taiwan application serial no. 111139347, filed on Oct. 18, 2022. The entirety of the above-mentioned patent application is hereby incorporated by reference herein and made a part of this specification.

### BACKGROUND

### Technical Field

The disclosure relates to a composite board structure and a manufacturing method thereof, and particularly relates to a polyester composite board structure and a manufacturing method thereof.

### Description of Related Art

Most of the existing plastic composite boards are manufactured by the method of heterogeneous lamination (PVC glued to ABS) or heterogeneous extrusion (PMMA/ABS), which are products that are not environmentally friendly and may not be recycled. Due to heterogeneous lamination, the existing manufacturing method requires coating or impregnating glue, and there are solvent volatilization and heating lamination in the manufacturing process. Therefore, it is a product that consumes energy and emits carbon.

Based on the above, a manufacturing method of a composite board has been developed, which meets the current demand for environmental protection, energy saving, and carbon reduction, and is an important subject of current research.

### SUMMARY

The disclosure provides a polyester composite board structure and a manufacturing method thereof. The composite board structure is manufactured with a single material without the process of gluing and heat pressing. Therefore, it meets the current demand for environmental protection, energy saving, and carbon reduction.

A manufacturing method of a polyester composite board structure of the disclosure includes extruding a polyester layer into a board using a multi-layer extrusion equipment, and laminating a polyester film by heat using a wheel during an extrusion process.

In an embodiment of the disclosure, the melting temperature of the multi-layer extrusion equipment is 250° C. to 290° C.

In an embodiment of the disclosure, the polyester layer includes a recycled polyester resin layer (which may be a PET or a general thermoplastic polyester, such as a PC, a PBT, a PBAT, etc., with a thickness of 0.3 mm to 6.0 mm, mainly providing the support of the composite board), a functional polyester layer (which may be a PET or a general thermoplastic polyester, such as a PC, a PBT, a PBAT, etc., with a thickness of 0.12 mm to 4.0 mm, mainly providing the functional characteristic of the composite board, such as the color, the pattern, etc.), or a protective polyester layer (which may be a PET or a general thermoplastic polyester, such as a PC, a PBT, a PBAT, etc., with a thickness of 0.06 mm to 1.0 mm, mainly providing the protection function of the composite board, such as the scratch resistance, the solvent resistance, etc.).

In an embodiment of the disclosure, the lamination temperature for laminating the polyester film by heat using the wheel is 80° C. to 180° C.

The polyester composite board structure of the disclosure is manufactured by the above-mentioned manufacturing method.

In an embodiment of the disclosure, the thickness is 0.6 mm to 10 mm.

In an embodiment of the disclosure, it includes 1 to 5 layers of polyester layers and 1 to 2 layers of polyester films (which may be general transparent PET films or printed PET films, or even general thermoplastic polyester films, such as PCs, PBTs, PBATs, and other films, with a thickness of 12 um to 250 um, mainly providing the additional function for the composite board, such as the decorative pattern, the anti-bacterial and anti-mildew, the wear-resistant and scratch-resistant properties).

In an embodiment of the disclosure, the polyester layer includes the recycled polyester resin layer (which may be the PET or the general thermoplastic polyester, such as the PC, the PBT, the PBAT, etc., with the thickness of 0.3 mm to 6.0 mm, mainly providing the support of the composite board), the functional polyester layer (which may be the PET or the general thermoplastic polyester, such as the PC, the PBT, the PBAT, etc., with the thickness of 0.12 mm to 4.0 mm, mainly providing the functional characteristic of the composite board, such as the color, the pattern, etc.), or the protective polyester layer (which may be the PET or the general thermoplastic polyester, such as the PC, the PBT, the PBAT, etc., with the thickness of 0.06 mm to 1.0 mm, mainly providing the protection function of the composite board, such as the scratch resistance, the solvent resistance, etc.).

Based on the above, the disclosure provides the polyester composite board structure and the manufacturing method thereof. The composite board structure is manufactured with a single material. Without coating glue or heat pressing, the polyester film is tightly formed with the composite board through the temperature of the equipment owned (wheel), and has the decorative pattern, the anti-bacterial and anti-mildew, and the wear-resistant and scratch-resistant properties. Therefore, it meets the current demand for environmental protection, energy saving, and carbon reduction.

### DESCRIPTION OF THE EMBODIMENTS

Hereinafter, embodiments of the disclosure will be described in detail. However, the embodiments are exemplary, and the disclosure is not limited hereto.

A range represented by “one value to another value” as used herein is a general representation that avoids listing all the values in the range in the specification. Accordingly, the recitation of a particular numerical range includes any numerical value within that numerical range as well as a smaller numerical range bounded by any numerical value within that numerical range, such that the arbitrary numerical value and the smaller numerical range were as if written in the description of the specification.

The disclosure provides a polyester composite board structure and a manufacturing method thereof. The manufacturing method includes extruding a polyester layer into a board using a multi-layer extrusion equipment, and laminating a polyester film by heat using a wheel during an extrusion process.

In the embodiment, the melting temperature of the multi-layer extrusion equipment is, for example, 250° C. to 290° C., and two or three multi-layer extrusion equipment may be used to manufacture the upper layer, the middle layer, or the bottom layer, respectively. The polyester layer may include a recycled polyester resin layer (which may be a PET or a general thermoplastic polyester, such as a PC, a PBT, a PBAT, etc., with a thickness of 0.3 mm to 6.0 mm, mainly providing the support of the composite board), a functional polyester layer (which may be a PET or a general thermoplastic polyester, such as a PC, a PBT, a PBAT, etc., with a thickness of 0.12 mm to 4.0 mm, mainly providing the functional characteristic of the composite board, such as the color, the pattern, etc.), or a protective polyester layer (which may be a PET or a general thermoplastic polyester, such as a PC, a PBT, a PBAT, etc., with a thickness of 0.06 mm to 1.0 mm, mainly providing the protection function of the composite board, such as the scratch resistance, the solvent resistance, etc.). The lamination temperature for laminating the polyester film by heat using the wheel is 80° C. to 180° C. For example, the wheel may include three rollers, but the disclosure is not limited hereto. The polyester composite board structure manufactured by the manufacturing method of the disclosure has a thickness of, for example, 0.6 mm to 10 mm, and may include 1 to 5 layers of polyester layers and 1 to 2 layers of polyester films.

To sum up, the disclosure provides the polyester composite board structure and the manufacturing method thereof. The composite board structure is manufactured with a single material. Without coating glue or heat pressing, the polyester film is tightly formed with the composite board through the temperature of the equipment owned (wheel), and has the decorative pattern, the anti-bacterial and anti-mildew, and the wear-resistant and scratch-resistant properties. Therefore, it meets the current demand for environmental protection, energy saving, and carbon reduction. In addition, the recycled polyester resin layer may be used to extrude into a board, which meets the trend of low-carbon green products.

What is claimed is:

1. A manufacturing method of a polyester composite board structure, comprising:
extruding a polyester layer into a board using a multi-layer extrusion equipment, and laminating a polyester film by heat using a wheel during an extrusion process.

2. The manufacturing method of the polyester composite board structure according to claim 1, wherein a melting temperature of the multi-layer extrusion equipment is 250° C. to 290° C.

3. The manufacturing method of the polyester composite board structure according to claim 1, wherein the polyester layer comprises a recycled polyester resin layer, a functional polyester layer, or a protective polyester layer.

4. The manufacturing method of the polyester composite board structure according to claim 1, wherein a lamination temperature for laminating the polyester film by heat using the wheel is 80° C. to 180° C.

5. A polyester composite board structure, manufactured by using the manufacturing method of the polyester composite board structure according to claim 1.

6. The polyester composite board structure according to claim 5, wherein a thickness is 0.6 mm to 10 mm.

7. The polyester composite board structure according to claim 5, comprising 1 to 5 layers of polyester layers and 1 to 2 layers of polyester films.

8. The polyester composite board structure according to claim 5, wherein the polyester layer comprises a recycled polyester resin layer, a functional polyester layer, or a protective polyester layer.
